(19) United States
(12) Patent Application Publication
(10) Pub. No.: US 2018/0251624 A1
(43) Pub. Date: Sep. 6, 2018

(54) Procedure for the devulcanization of scrap rubber and/or elastomers and apparatus therefor

(71) Applicant: Harald Rust, Bochum (DE)

(72) Inventor: Harald Rust, Bochum (DE)

(21) Appl. No.: 15/932,331

(22) Filed: Feb. 16, 2018

Related U.S. Application Data
(63) Continuation-in-part of application No. PCT/EP2016/001015, filed on Jun. 16, 2016.

(30) Foreign Application Priority Data
Aug. 16, 2015 (DE) 10 2015 010 460.8

(51) Int. Cl. C08J 11/06; B29B 17/04

(52) U.S. Cl. CPC C08J 11/06; B29B 17/04; B29K 2105/26; B29B 2017/0464; C08J 2321/00

(57) ABSTRACT

A procedure for the devulcanization of scrap rubber and/or elastomers and apparatus therefor. The abstract of the disclosure is submitted herewith as required by 37 C.F.R. § 1.72(b). As stated in 37 C.F.R. § 1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CROSS-REFERENCE TO RELATED APPLICATIONS

The subject matter of the present application is related to the subject matter of U.S. application Ser. No. 13/558,880, filed Jul. 26, 2012, which issued on Feb. 17, 2015, as U.S. Pat. No. 8,957,119, and is related to the subject matter of U.S. application Ser. No. 14/595,888, filed Jan. 13, 2015.

### CONTINUING APPLICATION DATA

This application is a Continuation-In-Part application of International Patent Application No. PCT/EP2016/001015, filed on Jun. 16, 2016, which claims priority from Federal Republic of Germany Patent Application No. 10 2015 010 460, filed on Aug. 16, 2015. International Patent Application No. PCT/EP2016/001015 was pending as of the filing date of this application. The United States was an elected state in International Patent Application No. PCT/EP2016/001015.

### BACKGROUND

### 1. Technical Field

The present application relates to a procedure for the devulcanization of scrap rubber and/or elastomers and apparatus therefor.

### 2. Background Information

Background information is for informational purposes only and does not necessarily admit that subsequently mentioned information and publications are prior art.

Rubber comprises natural rubber and/or synthetic elastomers, whose molecules have been subjected to crosslinking. In this regard sulfur-carbon bonds and sulfur-sulfur bonds inter alia between the molecules are known. One may also use the term crosslinked compounds. Crosslinking drastically modifies the material properties, such as, for example, the strength, elasticity and the heat deformation resistance.

Rubber is predominantly used in the automobile industry. The toughness of automobile tires is well known. The tires are subject to wear as a function of the distance driven in kilometers or miles. The wear can be measured by noting how much of the tire profile has worn away. If the tire profile has less than a certain thickness, then the tire has to be changed or may be changed. Due to the toughness of the tire material, it is difficult to destroy or recycle or reuse the tire material, and thus old tires or waste rubber tend to accumulate in waste sites and other locations.

Although various proposals for the chemical reconditioning of waste rubber have been made, the costs are such that up to now hardly any use has occurred. Waste rubber is more often than not usually incinerated. In this regard, the cement industry has been a large consumer. The waste rubber is incinerated in rotary furnaces. The cement rotary furnace has a long incineration path, such that non-incinerated gases are post-combusted. Any environmental pollution from the non-incinerated gases from waste tires is thus excluded. However, the cement industry generally demands a waste disposal fee for burning the old tires.

The waste disposal of old tires is moreover no longer regarded as topical or an acceptable approach in the current market. As a result, much effort has long been spent on trying to recycle rubber and similar elastomers, and various approaches have been taken.

For example, some modifying agents have been employed for the devulcanization of crosslinked elastomers and rubber. These modifiers comprise wholly or partially adipic acid or oxalic acid. Additives that comprise sulfur, zinc oxide and stearic acid have also been used.

In another example, Edelanu extracts that are obtained from oil processing, such as kerosene, nitrobenzene, furfural, phenol, and dichlorodiethylene ether, have been proposed as modifiers.

Some amine compounds have been proposed to be utilized as devulcanization agents/modifiers. Some aromatic oil, naphthenic oil or paraffinic oil may also be utilized as a devulcanization agent. Additionally, 2-butanol and carbon dioxide may be utilized as the devulcanization agent. Other modifiers may be possible. Moreover, the oil is itself obtained from the recycle process.

The modifiers have the disadvantage that they remain totally or partially in the recycled product, thereby quite strongly limiting the utilization of the product.

To avoid this disadvantage, a chemical-free devulcanization is also known. For example, microwaves and ultrasound can be used. The waves generate a high mechanical stress on the rubber and elastomers which is intended to break the molecular chains. The mechanical stress can be complemented by the use of heat or high vapor pressures. However, this type of devulcanization can often be regarded as being inadequate.

In a devulcanization method according to international publication WO2011/091966, which is incorporated by reference herein, crosslinked waste rubber and crosslinked elastomers, which are at least partially degradable mechanically and/or thermally, are devulcanized by means of extruders. For example, waste rubber and elastomers that are crosslinked with sulfur compounds are intended to be devulcanized. The sulfur is liberated by mechanical and thermal stressing and separated from the rubber or elastomers. In this method, a planetary roller extruder is used to generate the mechanical stress.

The waste rubber is optionally strongly cooled and in the highly cooled state comminuted in a mill. When in the cooled state the comminution is easier because the resilience of the rubber is reduced. The colder the rubber, the easier is the comminution.

In this method, rubber and elastomers may be fed as chips to the extruder. The average diameter of the chips can be, for example, five to forty millimeters, and in another example, fifteen to thirty millimeters.

The temperature of the material processed in the planetary roller extruder can be controlled very well because the processed material or rubber and elastomer is rolled out very thinly with a large surface area. The planetary roller extruder can thus act as a large surface area heat exchanger. Single-screw and twin-screw extruders of a comparable size possess a comparatively small heat exchange surface.

Planetary roller extruders possess a centrally-arranged, driven central spindle. The exterior of the central spindle is usually provided with involute toothing. Other types of toothing also exist. The involute toothing usually has a forty-five degree taper of the teeth. Different sizes of teeth also exist. Differentiation is made according to tooth modules.

In the planetary roller extruder, the central spindle is surrounded by a housing that possesses an inner toothing. The inner toothing has the same tooth module as the external toothing on the central spindle. A plurality of planetary spindles are positioned about the circumference of the central spindle between the housing and the central spindle. The planetary spindles possess an external toothing with the same module as the central spindle and the housing toothing. The planetary spindles mesh with the central spindle and with the inner toothing of the housing. The rotating planetary spindles exhibit a forward slide in the machine direction on a slide ring or thrust ring, such that their orbit or position is defined in the axial direction.

In a planetary roller extruder, the feedstock or material to be extruded is generally rolled in a thin layer between the inter-meshing teeth. This produces a strong kneading action on the waste rubber in the devulcanization method according to international publication WO2011/091966. Heat is transferred into the waste rubber due to the kneading action.

This kneading action can be influenced by different numbers and/or different designs of the planetary spindles. The number of planetary spindles can be, for example, at least five, and, in another example, at least six. The greater the diameter of the central spindle, the more planetary spindles are usually provided in a module/section. Thus, for example, with larger sizes of the central spindle, 24 or more planetary spindles can be readily employed.

The planetary spindles can be designed, for example, as conventional spindles, as transversal mixing spindles, or as back-cut spindles. Some examples of transversal mixing spindles and back-cut spindles may possibly be found in published German patent application DE102004048440 or in published U.S. Pat. No. 7,476,416, which publications are incorporated by reference herein. The conventional spindle has the same toothing continually or substantially continually from one end to the other.

The transversal mixing spindle is derived from the conventional spindle. Circular circumferential recesses are worked intermittently into the toothing in the transversal mixing spindle, such that, as viewed from the side of a spindle, one can perceive a meandering contour.

The back-cut spindle is also derived from the conventional spindle. Here, however, the conventionally toothed spindle is equipped with a contrary-running toothing that crosses the normal toothing. This means that gaps of a certain shape and sequence are cut into the teeth of the conventional toothing with the contrary-running toothing. The remaining teeth of the conventional toothing are stud-shaped. The gaps reduce the conveying action of the planetary spindles, whereas the kneading action increases. Moreover, the kneading with the studs differs from the kneading with the conventional spindle and the transversal mixing spindle.

The cited published texts on the transversal mixing spindles and back-cut spindles describe further useful details on planetary roller extruders that are suitable for devulcanization.

According to the method of international publication WO2011/091966, the temperature of the processed material is brought to the desired level for devulcanization in the planetary roller extruder by supplying heat and by cooling. This level is between 250 degrees and 350 degrees Celsius, or, for example, between 250 and 300 degrees Celsius. The kneading action and the thermal action are maintained for one to four minutes, or in one possible example, one and one-half to three-minutes. This duration corresponds to the residence time in the planetary roller extruder.

The sulfur bonds are broken apart by kneading and heating the scrap rubber in the planetary roller extruder. The sulfur is converted into the gaseous state. The gas is suctioned off. In the extrusion technology, this is called degassing.

The desired material-dependent kneading action and temperatures can be determined exactly or generally from the results of a few tests, in which the residence time and the temperature are modified.

A successful devulcanization of rubber and elastomers under appropriate conditions of processing time/residence lime yields a fluffy material of low strength. If the temperature is too high, the processed material/feedstock may be seen to be overheated or, for example, scorched. If the temperature is too low, the de-crosslinking will not be sufficiently accomplished, and thus the extruded material, although flexible, will still exhibit at least, to some extent, a degree of strength.

The planetary roller extruder is especially suitable for the desired heating of scrap rubber when, in a known manner, the inner side of the housing has a liner that, on the central spindle-side, is equipped with the described internal toothing and, on the outside, is equipped with an identical conventional toothing or another conventional toothing. The liner is, for example, shrunk into the housing. In order to shrink the liner into the housing, the liner is cooled so that its diameter is sufficiently reduced to allow it to be pushed into the housing. When reheated, the liner expands and becomes firmly seated in the housing. The housing may also be shrunk onto the liner. In this case the housing is heated and expands, such that the liner can be pushed into it. As it cools down, the housing firmly encloses the liner.

In both shrinking procedures, the housing locks the flights of the external toothing on the liner. In this way the flights are utilized as channels for the passage of temperature control media.

The channels are, for example, connected together on the housing ends by an annular channel. One annular channel is provided on the feed side and connected to a supply line. The other channel is provided on the discharge side and connected to a discharge line. Both lines are components of a temperature control arrangement or system.

Oil is used as the temperature control medium for the devulcanization. The oil is pumped through the channels. Depending on the oil temperature, this pumping of oil causes cooling or heating.

Depending on the material properties of the scrap rubber, one extruder can be used if it is long enough to accomplish the total devulcanization procedure therein. This means that the extruder is long enough to achieve the desired residence time sufficient for total devulcanization.

However, extruders may be used that are composed of modules or sections that are joined flush against one another. Each module possesses its own housing, own planetary spindle, and own thrust ring. A common central spindle is, for example, provided for all or most or some of the flushly-joined modules or sections.

The optional overall or partial length of the modules or sections is less than or equal to 800 millimeters, or, for example, less than or equal to 600 millimeters, or in a further example, less than or equal to 500 millimeters.

Shorter lengths of the individual modules or sections, or of all or some or most modules or sections, may allow different temperature requirements to be met. Moreover, the temperature control on a longer extruder module or extruder section can also be sub-divided into various sections that lay axially one behind the other.

However, module lengths of more than 1000 millimeters, for example 1400 millimeters, may also be used.

In general, the greater the diameter of the extruder, the greater the output. An increased output may require and/or desire a longer residence time of the rubber and elastomers in the extruder and require and/or desired a greater extruder length.

The modular construction or sectional construction also allows the kneading action of the planetary roller extruder to be altered by altering the toothing or by mounting modules with different toothing. Insofar as identical or substantially identical modules are already provided, an alteration of the kneading action and the residence time can still be achieved afterwards by changing the planetary spindles or by reducing the number of planetary spindles. This is a substantial practical advantage when the feedstock is changed.

In this context, back-cut spindles can be combined with conventional spindles and/or with transversal mixing spindles. The back-cut spindles represent the one extreme for the processing of rubber in the extruder, whereas the effect of transversal mixing spindles and conventional spindles diverges from this. If it appears that the residence time is too long, then one or more back-cut spindles may be exchanged for transversal mixing spindles or conventional spindles. Transport spindles may optionally also be used to shorten the residence time. This means that one or more back-cut spindles can be replaced by transport spindles. An example of a transport spindle may be found in published European patent EP702739, which is incorporated by reference herein.

The transport spindles are also derived from the conventional spindles. To form a transport spindle, one or more teeth are milled out of the conventional toothing of a conventional spindle.

For processing rubber or the like, different lengths of the planetary spindles are also advantageous, such that the material fed into the planetary roller module is gently and not abruptly seized by all or most of some of the toothing.

The application of the process according to the method of international publication WO2011/091966 afforded a successful devulcanization of scrap rubber. The equipment used is composed of a feed part and various planetary roller modules.

### OBJECT OR OBJECTS

An object of the present application is to improve the devulcanization of rubber or similar elastomers, and, in one possible exemplification, to raise the economic viability of devulcanization using a planetary roller extruder.

### SUMMARY

This objective can be achieved through the exemplifications disclosed herein and the features and aspects thereof.

The present application is based on the consideration of separating the heating provided to heat the feedstock after it has left the feed part up to the start temperature for the devulcanization from the devulcanization.

The use of a dispersion ring is possible for the heating zone. A dispersion ring, generally speaking, is a ring or ring-shaped disk with an opening therein. The central spindle passes through the dispersion ring, whereas the planetary spindles do not, as the diameter of the opening in the dispersion ring is large enough to accommodate the central spindle, but too small to accommodate the planetary spindles. The dispersion ring is similar to a thrust ring or a stop ring or similar ring or plate or holder that accommodates the central or sun spindle, but essentially blocks or holds in place the planetary spindles and prevents them from advancing axially as they rotate. However, the diameter of the opening in the dispersion ring is smaller than the diameter of the opening in a thrust ring, in that the opening in the thrust ring is generally at least large enough to permit a toothed central spindle to pass therethrough, whereas the opening in the dispersion ring is usually smaller.

The dispersion ring is designed to contribute to the mechanical processing of the feedstock. Moreover, the dispersion ring homogenizes the material flow into the heating zone. This facilitates the control of the heating.

According to the present application, the devulcanization zone is the zone, in which
after the homogenization by a dispersion ring
under concomitant mechanical processing of the scrap rubber in the planetary roller extruder
the material is degassed.

Moreover, it is advantageous to sub-divide the devulcanization zone into a start phase and into the phase for further devulcanization.

From the perspective of the present application, the sulfur that is released by breaking up the molecular crosslinks has to or should be at least largely discharged from the extruder in order to obtain a raw material of sufficient quality.

The separation according to the present application of the heating zone from the devulcanization zone is achieved by the modular design of the planetary roller extruder, wherein the heating zone is associated with a distinct planetary roller module having a separate temperature control (cooling or heating).

In the extreme case, the devulcanization can take place in a single planetary roller module. In at least one possible exemplification, however, a plurality of planetary roller modules, each with separate temperature control (cooling or heating), are used. Moreover, it is advantageous to provide a separate planetary roller module with its own or separate temperature control (cooling or heating) for the start phase and for the heating zone. The dispersion ring at the beginning of the devulcanization zone is in one possible exemplification located between the heating module and the first module of the devulcanization zone.

Optionally, at least one additional dispersion ring may be used in the devulcanization zone at a distance from the first dispersion ring, in order to build up additional mechanical stress. As at the first dispersion ring the feedstock is mechanically stressed at the second dispersion ring by forcing the feedstock through a narrow slit passage on the dispersion ring.

According to the present application the slit passage on a dispersion ring is selected as a function of the relevant characteristics of the feedstock. For a powdered feedstock, a very narrow slit and long slit is chosen, which imperatively leads to the desired deformation and the thereby associated mechanical stress. The same applies for a fine-grained feedstock. With coarse material, a relatively larger and shorter slit leads to the desired deformation and the thereby associated mechanical stress. It is aimed to process materials that are as coarse as possible. That unburdens the preparation of the scrap rubber for the processing in the planetary roller extruder. This means that scrap rubber is, for example, shredded and/or milled down to a coarse granularity. This requires and/or desires less work, effort and costs than shredding and milling to a fine granularity. Savings are very high in comparison to a powder form. In other words, it is easier and thus more economical to convert the scrap rubber into coarse grains rather than into fine grains or powders. It would therefore be economically advantageous to design the extruder to handle coarse grains rather than only fine grains or powders.

The characteristics of the feedstock are modified after homogenization by the first dispersion ring and processing in the associated planetary roller extruder section. Rubber and elastomers become more resilient. This is taken into account for the choice of the next dispersion ring. The slit width and slit length of the dispersion rings is discussed below. This is understood to mean the opening between the dispersion ring and central spindle.

At a constant or substantially constant temperature dispersion rings are in one possible exemplification chosen with a slit width that decreases as the processing path increases and/or with a slit length that increases as the processing path increases. The processing path is the path along which the feedstock or treated material is processed. The processing path becomes greater the more planetary roller extruders are combined or employed together to form an extrusion unit.

For example, extruder units can result in which:
the opening width of the second dispersion ring compared to the opening width of the first dispersion ring is at least 5%, in one possible exemplification at least 10%, in another possible exemplification at least 15% less,
the opening width of the third dispersion ring compared to the opening width of the second dispersion ring is at least 5%, in one possible exemplification at least 10%, in another possible exemplification at least 15% and in yet another possible exemplification at least 20% smaller,
the opening width of the third dispersion ring compared to the opening width of the second dispersion ring is at least 5%, in one possible exemplification at least 10%, still more in another possible exemplification at least 15% and in yet another possible exemplification at least 20% smaller,
the opening width of the fourth dispersion ring compared to the opening width of the third dispersion ring is at least 5%, in one possible exemplification at least 10%, in another possible exemplification at least 15% and in yet another possible exemplification at least 20% smaller.

In this regard, based on the construction size of the spindles, the first dispersion ring for example can have the following slit widths:

| Construction size | Slit width |
|---|---|
| 50 mm | 4.5 mm |
| 70 mm | 4.5 mm |
| 100 mm | 7 mm |
| 150 mm | 7 mm |
| 180 mm | 9 mm |
| 200 mm | 8.5 mm |
| 250 mm | 8 mm |
| 280 mm | 13 mm |
| 300 mm | 16 mm |
| 350 mm | 16 mm |
| 400 mm | 17 mm |

The slit width or opening width of the slit on the dispersion ring refers to the gap between the external surface of the central spindle and opposite inner surface of the dispersion ring at the place in question.

The length of the slit of the dispersion rings depends on their thickness. The thickness can be for example one to twenty-five millimeters, in one possible exemplification three to twenty millimeters.

A modifiable slit length is advantageous. In case of doubt the slit length can be changed by exchanging one dispersion ring for another with a greater or smaller thickness. However, this may simultaneously or substantially simultaneously force the central spindle to be exchanged. The central spindle is in one exemplification left unchanged. For this the exchangeable dispersion rings can be equipped on the housing side with a collar of constant thickness and on the central spindle side with a flange that is optionally thicker or thinner.

The design with the thicker collar and thinner flange allow the dispersion ring to be composed of two or more segments that are put together around the central spindle and thereby engage with the flange into a groove or undercut of the central spindle.

In the region of the slit the dispersion rings can be exactly or substantially exactly or generally cylindrical. The dispersion rings are in one possible exemplification rounded on the flanges on the surface that forms the slit and equipped with a streamlined conicity, such that no deadzones are formed in the slit. The dispersion rings optionally have an entry cone and an outlet cone. The outlet cone can be longer than the entry cone.

The conical surfaces of the dispersion rings are in one possible exemplification at an angle of one degree to forty-five degrees, in another possible exemplification an angle of ten degrees to thirty-five degrees and in yet another possible exemplification an angle of fifteen degrees to thirty degrees to the central axis of the dispersion rings.

The surfaces of the undercut also belong to the surfaces formed by the slits. To avoid and/or minimize dead spaces the edges and corners of the undercut are also in one possible exemplification rounded. Dead spaces are spaces in which material can be deposited without being flushed away by inflowing material.

According to the present application the undercut in the central spindle in one possible exemplification remains unchanged, and changes are made to the slit, in one possible exemplification by its enlargement or reduction, and other shaping is made by changing the dispersion ring.

The deformability of the feedstock may be influenced by the temperature control of the extruder. Heating increases the deformability, cooling decreases the deformability. This can also be utilized in order to employ dispersion rings with a slit width or slit length which at other temperatures of the feedstock afford unsatisfactory processing of the feedstock.

With the modular design of the extrusion unit the dispersion rings can be arranged between each of the two planetary roller modules and/or between a module formed from the feed part and from a type of single screw and a subsequent planetary roller module. This facilitates the mounting and exchange of the dispersion rings, such that the dispersion rings can be matched to the relevant feedstock and to the relevant processing state in the unit. This applies in one possible exemplification to dispersion rings that do not engage into a groove of the central spindle.

However, for dispersion rings that do engage into a groove of the central spindle it may also be possible to exchange dispersion rings having a different slit length, without having to exchange the central spindle, as long as the groove can be retained.

The placement between two modules enables the dispersion rings to be clamped as the associated module housing ends are being clamped. This advantage is also usually exploited to mount the thrust rings that belong to a planetary roller module.

The thrust rings and the dispersion rings are in one possible exemplification integrated in a common construction when the dispersion rings for example are inserted between two planetary roller modules. The common construction can be a centering ring, into which the thrust rings and the dispersion rings are inserted. When the housing is clamped, for example, the housing of the rear module in the direction of flow can press against the dispersion ring, the dispersion ring can press against the thrust ring and the thrust ring can press against the housing of the downstream front module. At the same time these machine parts are centered, in that the centering ring is centered in the housing of the front module, the thrust ring and the dispersion ring is centered in the centering ring, and the housing of the rear module in the direction of flow is centered on the dispersion ring, because the dispersion ring protrudes somewhat against the centering ring and the protruding end is enclosed by the housing of the rear module.

A possibility of the arrangement of the dispersion rings between two neighboring planetary roller modules or between a feed module designed as a type of single screw and a planetary roller module can be so great that the module length is geared to the desired position of the dispersion rings.

Incidentally, by using central spindles that are similarly of a modular design a partial exchange of the central spindle can take place for increasing slit lengths. The exchange is then limited to the spindle part in question or the slit modification associated with the exchange of the spindle part in question complements the slit formation associated with an exchange of the dispersion ring.

In the modular design a central spindle often comprises a central shaft, on which are slid toothed sleeves that are themselves modules of the central spindle. The sleeves are braced against each other with the shaft. Moreover, a tongue and groove connection can be provided between the shaft and the sleeves. The torque needed and/or desired to move the central spindle is transferred through the shaft onto the sleeves.

The torque is usually generated with a drive motor and transferred through a gear onto the central spindle.

Moreover, it is possible to interlock the various sleeves with a type of toothed coupling, such that the required and/or desired torque can be directly transferred from the gear onto the sleeves. One sleeve imparts the torque to the other sleeve.

The sleeves, on the external circumference, carry the required and/or desired toothing for cooperating with the planetary spindles in a planetary roller extruder or planetary roller module.

Insofar as a groove for a dispersion ring is provided in the central spindle then the groove can be formed by an externally wholly or partially smooth sleeve or central spindle module. To change the groove that corresponds to a dispersion ring another matching module can be exchanged for an existing central spindle module.

Degassing is carried out, in one possible exemplification by means of a side arm extruder, wherein the side arm extruder utilized for degassing in one possible exemplification sits perpendicularly or substantially perpendicularly to the planetary roller extruder or to its associated planetary roller module.

To continue the devulcanization it is advantageous if an additional degassing is provided after each additional dispersion ring. The additional degassing is in one possible exemplification also carried out again through side arm extruders. In addition, degassing may be carried out at the extruder outlet. In this case an additional dispersion ring and gas suction are provided at the extruder outlet. Gas suction at the extruder outlet is very effective, because the gas, due to its heat, expands, is released from the feedstock and bubbles up.

The use of side arm extruders for degassing allows the gas to be suctioned off very well. This occurs at a short distance from the dispersion ring that is upstream of the module in question. The largest cavity is formed there with the specified partial filling of the module.

If a unit has four planetary roller modules there results according to the present application with the separate heating phase and the separate start phase a total of five planetary roller modules. This may result in a greater total length, however, the total length of the unit according to the present application in one possible exemplification does not essentially differ from the length of a unit. According to the present application, the modules for the heating zone and for the start phase together should not be longer than a planetary roller module. However, the present application also includes a greater total length or a shorter total length.

The modules for the heating zone and the start phase can optionally have the same length.

The following possible lengths are shown as a function of the construction size of the planetary roller extruders or modules

| | Module length | Module length |
|---|---|---|
| Size | Heating zone | Start phase |
| 50 to 70 mm | 100 to 300 mm | 100 to 300 mm |
| 100 to 150 mm | 250 to 600 mm | 250 to 650 mm |
| 170 to 250 mm | 300 to 650 mm | 300 to 650 mm |
| 280 to 300 mm | 320 to 800 mm | 320 to 800 mm |
| (heavy-duty design) | | |
| 350 mm | 300 to 650 mm | 300 to 650 mm |
| 400 mm | 320 to 800 mm | 120 to 800 mm |
| (heavy-duty design) | | |
| 400 mm | 320 to 800 mm | 320 to 800 mm |
| 500 to 1000 mm | 350 to 1000 mm | 350 to 1000 mm |
| 500 to 1000 mm | 350 to 1000 mm | 350 to 1000 mm |
| (heavy-duty design) | | |

The construction size corresponds to the reference diameter or pitch circle diameter of the inner toothing in the housing or in the housing liner.

The energy needed and/or desired for the start of the devulcanization is supplied in the heating zone. This is supplied by the mechanical processing in the heating zone and by heating the heating zone. The higher the energy introduced into the feedstock by mechanical processing the less energy needs to be or should be supplied by heating and vice versa. The greater the heating the lower the required and/or desired mechanical processing. The present application has recognized that strongly heating with a temperature control agent at a temperature higher than 300 degrees Celsius with a lower rotational speed of the central spindle is possible.

A temperature of more them 320 degrees Celsius is desired there, in one possible exemplification a temperature of more than 340 degrees Celsius is provided. The temperature of the heating agent can also be between 350 and 400 degrees Celsius. As a result of the short residence time of the feedstock in the heating zone and as a result of the intensive mixing of the material in the heating zone and the thereby associated energy input the feedstock is thus heated very rapidly to the start temperature for the devulcanization. The start temperature is material-dependent and is appropriately determined in the laboratory. The start temperature can also be ascertained in the unit, in that
a temperature is set that is certainly in the starting region and
the temperature is then lowered until the discharged devulcanized material attains the desired quality.

The start temperature is in one possible exemplification below 300 degrees Celsius and the temperature in additional parts of the devulcanization zone is not raised above the start temperature. In one possible exemplification, the temperature in the additional parts of the devulcanization zone is lower than the start temperature. In this regard it may be appropriate to reduce the temperature from planetary roller module to planetary roller module in order to maintain the viscosity of the feedstock at the same level during the devulcanization. The viscosity may also be modified by changing the cooling and the heating as needed and/or desired.

With a constant or substantially constant viscosity of the feedstock, the same dispersion rings may be used in the planetary roller modules provided in the devulcanization zone. This facilitates stock sourcing for the dispersion rings. If it is desired to modify the viscosity, different dispersion rings are in one possible exemplification used for further deformation work in the devulcanization zone.

The temperature of the temperature control agent is comparable to the temperature of the feedstock or treated goods. For the cooling “comparable” means: the temperature of the temperature control agent is lower than that of the feedstock in order to cause the required and/or desired temperature differential by creating the desired heat flow from the feedstock to the temperature control agent. For the heating “comparable” means: the temperature of the temperature control agent is higher than that of the feedstock in order to cause the required and/or desired temperature differential by creating the desired heat flow from the temperature control agent to the feedstock.

Setting a temperature that is lower than the start region and subsequently increasing the temperature is not recommended because it can easily lead to a shut down.

Commercially available oils can be used as the temperature control agent up to a temperature of 350 degrees Celsius. Above 350 degrees Celsius, oil may also be used as the temperature control agent. However, according to the present application the oil should be kept under nitrogen or another inert agent in order to counteract ignition of the oil.

When controlling the temperature of the feedstock, it is possible to provide temperature control to the thrust rings and/or intermediate rings and/or dispersion rings. For this, appropriate channels for passing the temperature control agent are then provided in the rings. If the rings are arranged either tightly on the slit, or even in the slit between the planetary roller modules, then the temperature control agent can be fed with a tube through the slit to the rings or discharged through the slit away from the rings.

At least the temperature of the feedstock or of the processed material is in one possible exemplification controlled at the thrust rings and/or intermediate rings and/or dispersion rings. In one possible exemplification, the pressure is controlled at the dispersion rings, and, in another possible exemplification, in front of and/or behind the dispersion rings.

A multi-shell housing design of the planetary roller modules with a thin, inner-toothed housing liner is advantageous for the heating of the present application of the feedstock. The thinner the housing liner the better the heat transfer from the temperature control agent to the feedstock. The reduction in thickness is limited by the required and/or desired stability of the housing liner.

When the housing has a shrink connection with the housing liner this favors a low thickness.

An intensive degassing is provided in the start phase of the devulcanization. According to the present application, a short processing section or degassing section may be chosen for this.

If the planetary roller modules have a fill level of less than 90%, in one possible exemplification less than 80%, in another possible exemplification less than 70%, this is possible for the degassing. It may also be appropriate to have fill levels of less than 60% and even less than 50%. The fill level becomes less with an increased rotational speed.

The degassing devices are each flange-mounted there on the planetary roller modules where a cavity volume is formed due to the fill level being less than 100%.

The degassing devices can be connected to a common suction line. The suctioned off gases are cleaned prior to being released into the surrounding air. An activated carbon filter can be used as a simple and effective cleaning filter.

The results of the separation according to the present application between heating zone and devulcanization zone are astonishing.

In the heating zone according to the present application the feedstock can be optimally prepared for the start of the devulcanization. Some start conditions can be accomplished in the start phase independently of the subsequent processing.

Whereas operational disruptions may be expected in larger installations with the mode of operation, the application of the teaching according to the present application affords a more stable process with a well devulcanized extruded material.

Mooney viscosities of 20 to more than 60, in one possible exemplification 30 to 50, in another possible exemplification 35 to 45 can be obtained. The viscosity of the extruded material is measured with a Mooney viscosimeter. The Mooney viscosimeter has a spindle that is rotated in the material sample at a defined material sample temperature. The torque required and/or desired for the rotation of the spindle gives an indication of the viscosity of the material sample. The cited Mooney viscosities refer to a temperature of 100 degrees Celsius.

Compared to some Mooney viscosities at the same temperature, the Mooney viscosities that can be achieved according to the present application are significantly higher.

In at least one possible exemplification of the present application, the stability of the process after initiation of the devulcanization is such that the rotational speed of the central spindle can be increased. The corresponding higher feed rate is synonymous with an increased output of the installation. With comparable installations and a comparable feedstock, the output of a process according to the present application could be readily increased in tests up to three times that obtained with an installation and mode of operation. Furthermore, an adjustment of the mode of operation according to the present application was possible in larger steps. This is of great importance for the question of admissible fluctuations of the feedstock.

Further, it was found that the devulcanization proceeds partly without additional extrusion work and by reducing the heating. This is clearly seen with the material as it exits the extruder. Depending on the length of the extruder and on the length of the upstream degassing section a significant gas emission was noted there which should be taken care of with a suction device in order to prevent and/or restrict unfiltered gas from escaping into the surroundings.

The above-discussed exemplifications of the present invention will be described further herein below. When the word “invention” or “exemplification of the invention” is used in this specification, the word “invention” or “exemplification of the invention” includes “inventions” or “exemplifications of the invention”, that is the plural of “invention” or “exemplification of the invention”. By stating “invention” or “exemplification of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

FIG. 1 shows an extrusion line for a process according to the present application for handling scrap rubber or similar elastomers;

FIG. 2 shows an example of a planetary roller extruder that includes a dispersion ring;

FIG. 3 shows an example of a planetary roller extruder with a heating-cooling arrangement;

FIG. 4 shows a simple illustration of an axial cross-sectional view of components of a planetary roller extruder, according to at least one possible exemplification; ⁻and

FIG. 5 shows a simple illustration of a side cross-sectional view of components of a planetary roller extruder, according to at least one possible exemplification.

### DESCRIPTION OF EXEMPLIFICATION OR EXEMPLIFICATIONS

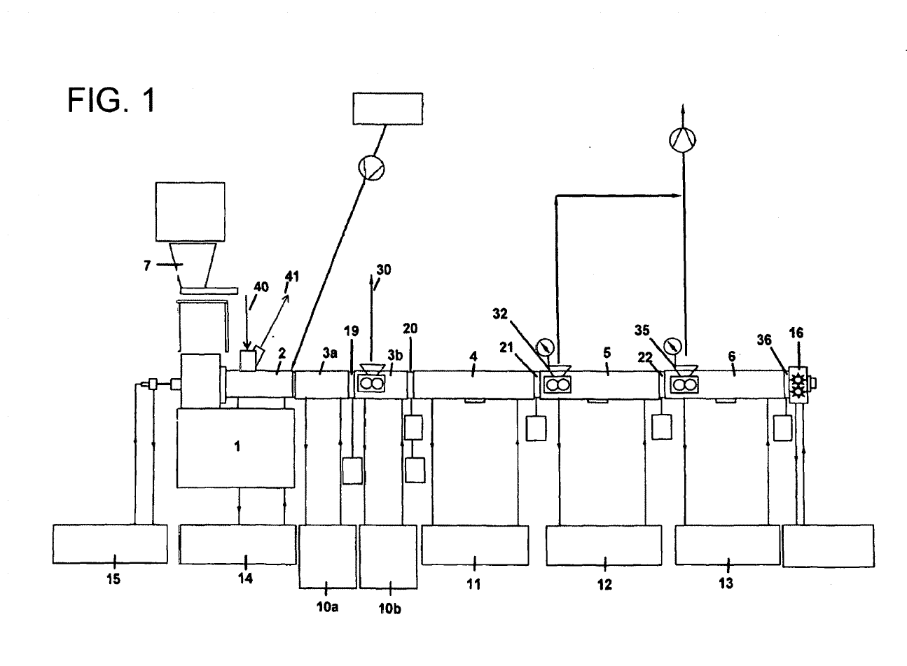

The extrusion line according to FIG. 1 has a construction size. The installation according to the present application comprises various sections 2, 3a, 3b, 4, 5, 6. Section 2 is a feed part and designed as a type of single-screw extruder.

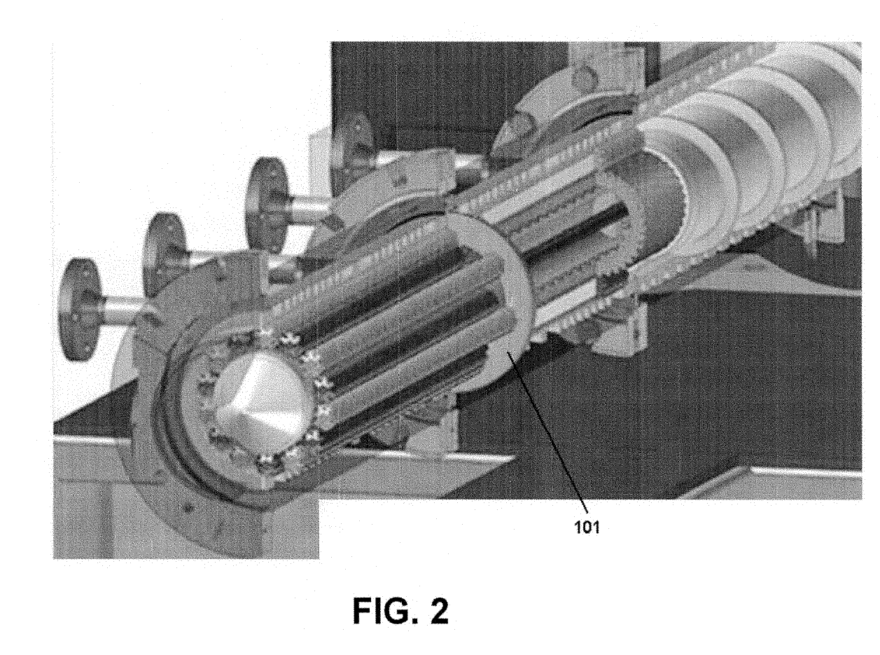

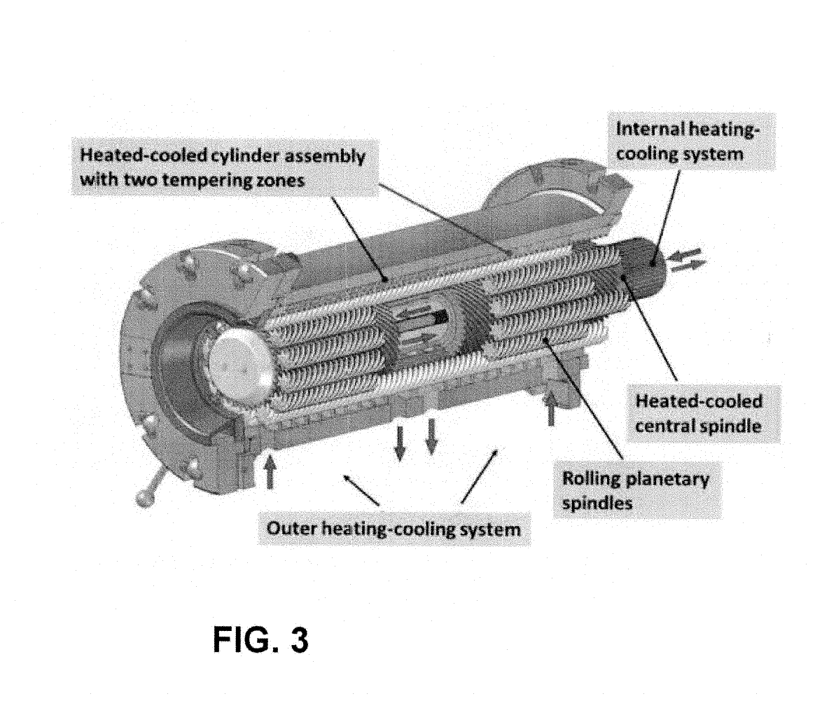

Sections 3a, 3b, 4, 5, 6 are planetary roller modules, examples of which may be seen in FIGS. 2 and 3. The various planetary roller modules include an internally toothed cylindrical housing, planetary spindles, and a central spindle. A common central spindle is provided here for the planetary roller modules and for the feed part. This means that the central spindle extends through the planetary roller modules and through the feed part 2 to the gear 1. The gear 1 is moved by a drive motor. Consequently the central spindle rotates in the extruder. The planetary spindles that mesh with the central spindle run around the central spindle and mesh with the internally toothed housing of the planetary roller modules. The length of each planetary roller module 4, 5, and 6 is 400 millimeters. The length of each planetary roller module 3a and 3b is 200 millimeters.

Each planetary roller module is equipped with five planetary spindles, though different designs can have lower or higher numbers of planetary spindles for each module, depending on the feedstock or material to be processed. The number of planetary spindles has an influence on the fill level of the planetary roller modules. The lower the number of planetary spindles the greater cavities can be produced. The planetary spindles of the modules 4 and 5 are designed as back-cut spindles and evenly distributed on the periphery of the central spindle. Among the planetary spindles of the module 6, three planetary spindles are likewise designed as back-cut spindles. The other planetary spindles of module 6 are designed as transport spindles. The planetary roller modules 3a and 3b possess more planetary spindles than the other planetary roller modules, namely six. Moreover, the planetary spindles of the modules 3a and 3b are equipped with a standard toothing. The standard toothing causes a higher mechanical stress of the scrap rubber than the planetary spindles provided in the other modules, whose back-cut spindles are very conducive for the degassing and whose transport spindles are conducive for both the degassing as well as for generating a considerable conveying effect. The scrap rubber is very strongly rolled out into thin layers in the standard toothing. This intensifies the heat flow.

Among the planetary spindles in the planetary roller modules 4, 5, 6, three back-cut spindles each have the same length of 373 millimeters. In contrast, the other planetary spindles are longer. They are 399 millimeters long. The different lengths of the planetary spindles advantageously draw in the scrap rubber into the active zones of the spindles.

Planetary roller modules 3a and 3b on the other hand are provided with three planetary spindles of this length. The other three planetary spindles have a shorter length of 373 millimeters. The planetary spindles slide on customary thrust rings, which, in at least one exemplification, can be connected to the dispersion rings.

The dispersion ring for the module 3a is labeled 19, the dispersion ring for the module 3b is labeled 20, the dispersion ring for the module 4 is labeled 21, and the dispersion ring for the module 5 is labeled 22. Moreover, one other dispersion ring 36 is provided on the last module 6. An example of a dispersion ring 101 can be seen in FIG. 2.

The modules 3b, 5, 6 are equipped with a degassing unit 30, 32, 35. The degassing units are formed by side arm extruders that extend perpendicular or substantially perpendicular to the associated modules. In at least one exemplification, the side arm extruders, according to the view in FIG. 1, extend horizontally toward the viewer.

In this regard the side arm extruder 30 is at a short distance from the dispersion ring 19, the side arm extruder 32 is at a short distance from the dispersion ring 21, the side arm extruder 35 is at a short distance from the dispersion ring 22.

Each side arm extruder is subjected to a negative pressure. During the degassing the side arm extruders are run empty, such that feedstock or processed material that is under high pressure in the extruder and tends to exit with the suctioned-off gas, is forced back again into the extruder.

In the exemplification, the scrap rubber, in finely divided form, is dosed into the feed part 2. The dosing unit is labeled 7, and the material inlet is labeled 40. At the material inlet there is also an opening 41, through which remaining material can be blown out when the line is shut down.

During the devulcanization process, the planetary roller modules 3, 4, 5 are temperature controlled with oil coolers 10a, 10b, 11, 12, 13.

The temperature control for the feed part 2 is labeled 14. A temperature control 15 is also provided for the central spindle, which is not visible in FIG. 1. However, an example of a type of a temperature control or heating-cooling system may be seen in FIG. 3.

When starting up, first oil is introduced into the feed part 2 by a pump 45 before scrap rubber is fed to the feed part 2. This prevents, restricts, and/or minimizes the moving extruder parts from running dry.

The scrap rubber introduced into the feed part 2 is subjected to mechanical deformation and stress by the screw of the feed part 2. This simultaneously heats the scrap rubber. In addition, the temperature control agent of the temperature control 15 is set for example to a temperature of 120 degrees Celsius. In other examples a higher or lower temperature can be used. The temperature control 15 is in one possible exemplification adjustable to 140 degrees Celsius.

The scrap rubber is pressed out of the feed part 2 into the module 3a that forms a heating zone. In the heating zone the scrap rubber is heated to a material-dependent start temperature for devulcanization. In one example, the start temperature is 310 degrees Celsius. For this the temperature control 10a of the module 3a is set to 330 degrees Celsius in the example. The scrap rubber is simultaneously intensively mixed and rolled out in the module 3a.

After the scrap rubber has been heated to the start temperature, it is pressed through the slit on the dispersion ring 19. After homogenization from the dispersion ring 19, the molecular chains of the scrap rubber are broken up to such an extent that sulfur can escape from the feedstock or processed material. The release of the sulfur is promoted by the intensive mixing and rolling out of the feedstock or processed material in the module 3b. The released, gaseous sulfur is simultaneously or substantially simultaneously suctioned off through the degassing unit 30.

The devulcanization of the feedstock is started in module 3b.

In order to achieve an adequate devulcanization the processing must or should be continued.

The feedstock or processed material is pressed out of module 3b into module 4. The feedstock or processed material passes the dispersion ring 20. In module 4 the feedstock or processed material is further processed and pressed through another dispersion ring 21. The thus-processed material is then further processed in module 5 and degassed.

After exiting the planetary roller module 5, the devulcanized scrap rubber is cooled down to 220 degrees Celsius in the planetary roller module 6 before exiting as a crumbly mass out of the extrusion line, and cooled down in a water cooler 16 to room temperature.

A water cooler 13 for the cooling is provided on the planetary roller module 6.

The feed part 2 is also equipped with a water cooler 14.

The cooling temperatures at the feed part and after the devulcanization are also material-dependent.

In the exemplification an internal cooling of the central spindle is also provided. The associated cooler 15, like the coolers 10, 11, 12, is an oil cooler and set to a temperature of 300 degrees Celsius.

The devulcanization is caused by the mechanical and thermal stressing of the scrap rubber in the extrusion line.

The dispersion rings 20, 21, 22 also contribute to the mechanical stress in the planetary roller modules 3, 4, 5.

In the exemplification the dispersion rings are arranged behind the thrust rings (not shown) in the machine direction of the scrap rubber through the unit.

In this regard, the inner diameter of the dispersion rings 20, 21, 22 is smaller than the external diameter of the central spindle. The dispersion rings 20, 21, 22 engage into the grooves (not shown) in the central spindle, such that the tooth gaps between the teeth of the central spindle are closed except for a narrow gap at the tooth base. The dispersion rings 20, 21, 22 are maintained between the corresponding ends of the planetary roller modules, such that the housing space around the central spindle is also closed and the scrap rubber is forced to pass through the narrow gap. The narrowing of the gap is material dependent and causes an extreme deformation and extreme mechanical stress of the feedstock.

In detail, the dispersion ring 20 is provided between the planetary roller modules 3 and 4, the dispersion ring 21 is provided between the planetary roller modules 4 and 5 and the dispersion ring 22 is provided between the planetary roller modules 5 and 6.

The dispersion rings 20, 21, 22 are clamped by clamping the cylindrical housing of the planetary roller modules 3, 4, 5, 6.

For this, the planetary roller modules 3, 4, 5, 6 possess on their ends typical flanges that are pushed against one another with clamping screws. The feed part 2 also possesses typical flanges. The feed part is clamped with these flanges on the one hand to the housing of the drive 1 and on the other hand with the planetary roller module 3.

For the dispersion rings 20, 21, 22, that in the exemplification engage into grooves of the central spindle, provision is made that these rings are composed of two halves in order to facilitate their mounting.

The mounting is mentioned below for the dispersion ring 20. The other dispersion rings 20, 21, 22 are mounted correspondingly.

After the feed part housing has been mounted, the central spindle with its end designed as a single screw is initially pushed into the feed part housing and coupled with the drive.

The housing of the planetary roller module 3 is then pushed over the central spindle and clamped with the feed part housing.

The planetary spindles of the planetary roller module 3 are then put in place. For this, the planetary spindles are rotatably pushed into their predefined position between the housing and central spindle. The position of the planetary spindles comprises an even distribution on the periphery of the central spindle and the already described toothing engagement of the planetary spindles with the inner toothing of the housing and the outer toothing of the central spindle.

After the planetary spindles have been put into position, the thrust ring for the planetary spindles is pushed over the central spindle and into a central opening of the housing end of the planetary roller module. The thrust ring has a wear resistant, hard metal coating in its contact area with the planetary spindles.

After the thrust ring has been put in position, the dispersion ring 20, comprising two halves, is moved to the thrust ring up against the machine. The halves are pushed at the same time into a groove of the central spindle. The dispersion ring is then centered with the help of a one-piece support ring that can be pushed over the central spindle and is centered in the same housing opening as the thrust ring in the planetary roller module 3. The dimensions of the support ring are such that it protrudes out of the end of the housing opening of the planetary roller module 3 and forms a centering means for mounting the following housing of the planetary roller module 4. The housing of the planetary roller module 4 is thus clamped with the housing of the planetary roller module 3 in the above described shape. This clamping simultaneously or substantially simultaneously clamps the thrust ring, the dispersion ring and the support ring.

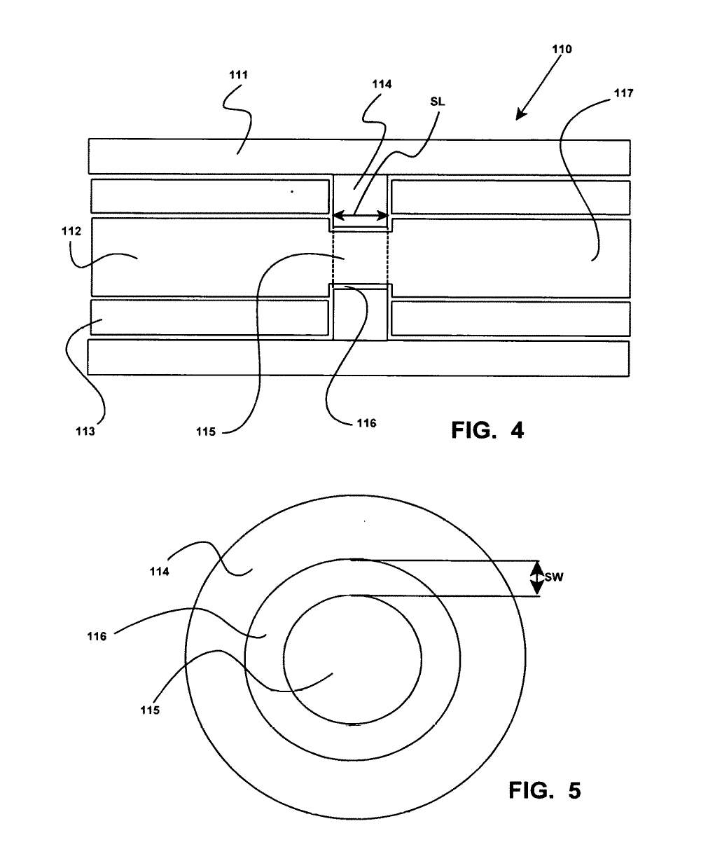

FIGS. 4 and 5 are provided for exemplary purposes to further explain a possible arrangement of components of a planetary roller extruder, such as the dispersion ring. FIG. 4 shows a simple illustration of a side cross-sectional view of components of a planetary roller extruder, according to at least one possible exemplification, and FIG. 5 shows a simple illustration of an axial cross-sectional view of components of a planetary roller extruder, according to at least one possible exemplification. According to these figures, the main components of a planetary roller extruder 110 are shown, such as a housing 111, a central or sun spindle 112, and planetary spindles 113. For purposes of simplicity, the teeth of the housing 111, the central spindle 112, and the planetary spindles 113 are not shown. A dispersion ring or dispersion ring assembly or arrangement 114 is mounted in the housing 111 and is disposed concentrically about a groove portion or recessed portion 115 of the central spindle 112. The groove portion 115, in one possible exemplification, is a smooth cylindrical portion that is essentially equivalent to the central spindle 115 without teeth, i.e., with the teeth removed or omitted. The diameter of the groove portion 115 is therefore smaller than the diameter of a toothed portion 117 of the central spindle 112. The dispersion ring 114 is in the shape of a ring that has an inner diameter that is larger than the diameter of the groove portion 115 of the central spindle 112, but smaller than the diameter of a toothed portion 117 of the central spindle 112. A small space or gap or slit 116 is therefore formed between the dispersion ring 114 and the groove portion 115. As discussed herein, this slit 116, due to its reduced size, causes an increase of the pressure on the feedstock as it is pushed or forced through the slit 116. The slit length SL is determined by the thickness of the dispersion ring 114. The slit length SL can be varied as desired by making the dispersion ring 114 thicker or thinner. It should be noted that the relative thickness of the dispersion ring 114 as shown in FIG. 4 is for illustrative purposes and should not be construed as limiting the size and/or dimensions of the dispersion ring 114.

FIG. 5 shows an axial cross-sectional view of the groove portion 115 and the dispersion ring 114, as viewed along the longitudinal axis of the center spindle 112, wherein the slit width SW of the slit 116 is shown. The slit 116 is enlarged or exaggerated to some degree in FIG. 5 in order to clearly show the slit width SW, although it should be understood that the slit width SW can be varied as desired to be larger or smaller, depending on the feedstock being processed and extruded.

It should also be noted that the interior side or wall of the dispersion ring 114 is shown in FIGS. 4 and 5 as being parallel to the outer surface or side wall of the groove portion 115. However, in another possible exemplification, the interior side or wall of the dispersion ring 114 could possibly have a conical or sloped or angled design, wherein the interior side or wall of the dispersion ring 114 is disposed at an angle with respect to the outer surface or side wall of the groove portion 115. As a result, the slit width SW could be one size in one portion of the dispersion ring 114 and another size in another portion of the dispersion ring 114. The varying of the slit width SW in the dispersion ring 114 can be selected to produce different forces on the feedstock.

According to the present application, scrap rubber is devulcanized in a planetary roller extruder.

The following patents, patent applications, patent publications, and other documents, except of the exceptions indicated herein, are hereby incorporated by reference as if set forth in their entirety herein except for the exceptions indicated herein, as follows: DE 60004885 T2, published on Jun. 3, 2004, having applicant LEVGUM LTD; DE 909041, published on Apr. 12, 1954, having applicant METALLGESELLSCHAFT AG; DE 60008279 T2, published on Dec. 16, 2004, having applicant DSM IP ASSETS BV; DE 60215210 T2, published on Aug. 23, 2007, having applicant FULFORD GROUP INC; DE 60306089T2, published on Dec. 28, 2006, having applicant GOODYEAR TIRE & RUBBER; DE 60120804 T2, published on Jan. 11, 2007, having applicant BRIDGESTONE CORP; DE 601280412; WO2011/091966, published Aug. 4, 2011, having applicant RUST & MITSCHKE ENTEX; DE 69329245 T2, published on Mar. 29, 2001, having applicant UNIV AKRON AKRON; DE 69724239 T2, published on Jun. 9, 2004, having applicant TOYODA CHUO KENKYUSHO KK; DE 102009019846, published Nov. 11, 2010, having applicant H C CARBON GMBH; DE 102009013839, published on Sep. 23, 2010, having applicant RUST & MITSCHKE ENTEX; DE102008063036, published Jul. 1, 2010, having applicant TESA SE; DE 102008018686, published on Oct. 15, 2009, having applicant RUST & MITSCHKE ENTEX; DE 102007058174, published on Jun. 4, 2009, having applicant RUST & MITSCHKE ENTEX; DE102007050466, published on Apr. 23, 2009, having applicant RUST & MITSCHKE ENTEX; DE 102007041486, published on May 15, 2008, having applicant RUST & MITSCHKE ENTEX; DE 102007040645, published on Mar. 5, 2009, having applicant RUST & MITSCHKE ENTEX; DE 10 2004 048 440, published on Jun. 9, 2005, having applicant RUST & MITSCHKE ENTEX; U.S. Pat. No. 7,476,416, issued on Jan. 13, 2009, having applicant TYNAN JOHN K. JR; and EP 702739, published on Mar. 27, 1996, having applicant DEKONT TEKNIK AB.

One feature or aspect of an exemplification is believed at the time of the filing of this patent application to possibly reside broadly in a method of devulcanizing vulcanized material comprising cross-linked rubber or cross-linked elastomers, using a planetary roller extruder comprising a housing, a central spindle, and planetary spindles disposed between and configured to mesh with said central spindle and said housing, said method comprising the steps of: feeding vulcanized material into a feed zone of said planetary roller extruder; operating said planetary roller extruder by rotating said central spindle about its rotational axis, and thereby both rotating said planetary spindles about each of their rotational axes and revolving said planetary spindles about said central spindle; feeding vulcanized material from said feed zone into a first treatment zone; generating mechanical and thermal stress on said vulcanized material in said first treatment zone by kneading and/or crushing to begin devulcanization; feeding treated vulcanized material from said first treatment zone, through a dispersion ring, and to a second treatment zone, and generating additional mechanical and thermal stress on said treated vulcanized material by restricting movement of said vulcanized material through said dispersion ring; generating additional mechanical and thermal stress on said treated vulcanized material in said second treatment zone by kneading and/or crushing to further and/or complete devulcanization; and said step of generating mechanical and thermal stress on said vulcanized material in said first treatment zone comprising: (A) heating said vulcanized material in a heating zone, which heating zone comprises its own set of planetary rollers and temperature control; and/or (B) starting devulcanization in a start zone, which start zone comprises its own set of planetary rollers and temperature control.

Another feature or aspect of an exemplification is believed at the time of the filing of this patent application to possibly reside broadly in the method, wherein the length of said heating zone and/or said start zone, relative to the diameter of the pitch circle the toothing on the inside of said housing, are as follows:

| Diameter Size | Module length | Module length |
|---|---|---|
| of Pitch Circle | Heating zone | Start zone |
| 50 to 70 mm | 100 to 300 mm | 100 to 300 mm |
| 100 to 150 mm | 250 to 600 mm | 250 to 650 mm |
| 170 to 250 mm | 300 to 650 mm | 300 to 650 mm |
| 280 to 300 mm | 320 to 800 mm | 320 to 800 mm |
| 350 mm | 300 to 650 mm | 300 to 650 mm |
| 400 mm | 320 to 800 mm | 120 to 800 mm |
| 400 mm | 320 to 800 mm | 320 to 800 mm |
| 500 to 1000 mm | 350 to 1000 mm | 350 to 1000 mm. |

Yet another feature or aspect of an exemplification is believed at the time of the filing of this patent application to possibly reside broadly in the method, wherein said step of heating said vulcanized material in said heating zone comprises quickly raising the temperature of said vulcanized material to a starter temperature for devulcanization using a temperature control agent having a temperature of one of: (C) at least 300° C., (D) at least 320° C., and (E) at least 340° C.

Still another feature or aspect of an exemplification is believed at the time of the filing of this patent application to possibly reside broadly in the method, wherein said vulcanized material in said start zone exhibits the required starter temperature and after leaving said start zone exhibits a lower temperature.

A further feature or aspect of an exemplification is believed at the time of the filing of this patent application to possibly reside broadly in the method, wherein said method further comprises selecting and setting a start temperature that is sufficiently high to be in a start range, and then reducing the selected temperature in steps until an optimal start temperature is reached.

Another feature or aspect of an exemplification is believed at the time of the filing of this patent application to possibly reside broadly in the method, wherein said planetary roller extruder comprises a plurality of dispersion rings and a plurality of planetary roller modules, wherein each dispersion ring is associated with a corresponding planetary roller module, such that processing linked with the dispersion rings is carried out on said vulcanized material in a plurality of steps.

Yet another feature or aspect of an exemplification is believed at the time of the filing of this patent application to possibly reside broadly in the method, wherein: each of said dispersion rings is disposed about said central spindle with space therebetween, such that slits are formed between said dispersion rings and said central spindle ro permit vulcanized material to pass through; the opening width of the slits is reduced with each processing step or with each planetary roller module, wherein: the opening width of a second dispersion ring compared to the opening width of a first dispersion ring is one of: at least 5% less, at least 10% less, or at least 15% less; the opening width of a third dispersion ring compared to the opening width of said second dispersion ring is one of: at least 5% less, at least 10% less, at least 15% less, or at least 20% less; and the opening width of a fourth dispersion ring compared to the opening width of said third dispersion ring is one of: at least 5% less, at least 10% less, at least 15% less, or at least 20% less; and said dispersion rings are exchangeable in order to permit modification of the opening width of said slits.

Still another feature or aspect of an exemplification is believed at the time of the filing of this patent application to possibly reside broadly in the method, wherein the lengths of said slits are defined by the thicknesses of said dispersion rings, which thicknesses are in the range of 1 to 25 mm, or are in the range of 3 to 20 mm, and the dispersion rings are exchangeable in order to permit modification of the lengths of said slits.

A further feature or aspect of an exemplification is believed at the time of the filing of this patent application to possibly reside broadly in the method, wherein said slits comprise a conical shape, with an inlet conus and/or an outlet conus and/or with rounded edges and/or with a conical surface inclination, with respect to the central axis of said dispersion rings, in the range of: 1 to 45°, 10 to 35°, or 15 to 30°.

Another feature or aspect of an exemplification is believed at the time of the filing of this patent application to possibly reside broadly in the method, wherein: said central spindle comprises groove portions about which said dispersion rings are disposed; said dispersion rings are composed of halves or a plurality of segments; the outer surface of each of said groove portions is rounded or cylindrical; and said groove portions remain unchanged in the event of an exchange of dispersion rings.

Yet another feature or aspect of an exemplification is believed at the time of the filing of this patent application to possibly reside broadly in the method, wherein some of said dispersion rings have different sizes and/or dimensions and/or shapes, wherein said different dispersion rings, on the side adjacent the housing, comprise a collar of constant thickness, and, on the side adjacent the central spindle, comprise a flange configured to engage with said groove portions, which flanges have different thickness.

Still another feature or aspect of an exemplification is believed at the time of the filing of this patent application to possibly reside broadly in the method, wherein said dispersion rings are configured to be placed between two planetary roller modules, and are configured to be arranged together with thrust rings of planetary roller modules in a single arrangement, in order to sufficiently strongly deform the vulcanized material being devulcanized as it passes through said slits.

A further feature or aspect of an exemplification is believed at the time of the filing of this patent application to possibly reside broadly in the method, wherein said planetary roller modules have a length selected to permit a desired positioning of said dispersion rings.

One feature or aspect of an exemplification is believed at the time of the filing of this patent application to possibly reside broadly in the method, wherein: said central spindle has a modular construction; said central spindle comprises a rod and a plurality of sleeves that disposed on said rod; said sleeves are clamped against one another with contact surfaces that engage in one another with teeth; said sleeves comprise a groove configured to engage with a dispersion ring; each of said sleeves comprises a toothing on its periphery that is configured to mesh with said planetary spindles; and said sleeves are exchangeable to change said grooves.

Another feature or aspect of an exemplification is believed at the time of the filing of this patent application to possibly reside broadly in the method, wherein one of said dispersion rings is disposed before said heating zone, and the opening width of said slit is sufficiently large to permit the vulcanized material to be pushed through but sufficiently small to promote strong deformation of the vulcanized material.

Yet another feature or aspect of an exemplification is believed at the time of the filing of this patent application to possibly reside broadly in the method, wherein said method further comprises: controlling the temperature at said planetary roller modules using a temperature control medium, which temperature control medium comprises oil; and preventing ignition of said oil at temperatures over 350° C. using nitrogen.

Still another feature or aspect of an exemplification is believed at the time of the filing of this patent application to possibly reside broadly in the method, wherein said method further comprises controlling the temperature at said dispersion rings.

A further feature or aspect of an exemplification is believed at the time of the filing of this patent application to possibly reside broadly in the method, wherein said method further comprises filling said planetary roller extruder with vulcanized material to a fill level of less than 80%, or less than 70%, or less than 50%.

Another feature or aspect of an exemplification is believed at the time of the filing of this patent application to possibly reside broadly In the method, wherein said method further comprises an additional degassing of said vulcanized material after leaving said planetary roller extruder, wherein said vulcanized material is mechanically stressed at the end of said planetary roller extruder by an additional dispersion ring.

Yet another feature or aspect of an exemplification is believed at the time of the filing of this patent application to possibly reside broadly in the method according to claim 19, wherein: said planetary roller modules in said heating zone and/or said start zone comprise standard spindles; said planetary roller modules in said second treatment zone comprise back-cut spindles and/or transport spindles and/or transversal mixing spindles for degassing; said method further comprises producing a devulcanized material having a Mooney viscosity of 20 to 60, or 30 to 50, or 35 to 45, as measured at a temperature of 100° C.

One feature or aspect of an exemplification is believed at the time of the filing of this patent application to possibly reside broadly in a process for devulcanization of crosslinked rubber and crosslinked elastomers, the molecular chains of which are destructible as far as the hydrocarbon molecules by mechanical and thermal stress, wherein the mechanical and thermal stress is generated in a planetary roller extruder, wherein the planetary roller extruder comprises a housing, planetary spindles and a central spindle, and the central spindle intermeshes with the planetary spindles and the planetary spindles intermesh with an internal toothing of the housing or with the internal toothing of a liner provided in the housing, such that a revolution of the central spindle causes the planetary spindles to rotate around the central spindle in the housing, wherein the planetary spindles of one extruder section slide with a facing surface at a thrust ring of this extruder section, wherein in the planetary roller extruder there is provided at least one dispersion ring that reduces the cross-sectional flow for the rubber and the elastomers more than does a thrust ring, wherein a separate heating zone with its own planetary roller module and its own temperature control is provided between the feed part and the devulcanization zone and/or a start phase with its own planetary roller module and its own temperature control is provided at the beginning of the devulcanization zone.

Another feature or aspect of an exemplification is believed at the time of the filing of this patent application to possibly reside broadly in the process wherein the use of modularly constructed planetary roller extruders having the following module lengths

| | Module length | Module length |
|---|---|---|
| Size | Heating zone | Start phase |
| 50 to 70 | 100 to 300 mm | 100 to 300 mm |
| 100 to 150 | 250 to 600 mm | 250 to 650 mm |
| 170 to 250 | 300 to 650 mm | 300 to 650 mm |
| 280 to 300 | 320 to 800 mm | 320 to 800 mm |
| (heavy-duty design) | | |
| 350 | 300 to 650 mm | 300 to 650 mm |
| 400 | 320 to 800 mm | 120 to 800 mm |
| (heavy-duty design) | | |
| 400 | 320 to 800 mm | 320 to 800 mm |
| 500 to 1000 | 350 to 1000 mm | 350 to 1000 mm |
| 500 to 1000 | 350 to 1000 mm | 350 to 1000 mm |
| (heavy-duty design) | | |

Yet another feature or aspect of an exemplification is believed at the time of the filing of this patent application to possibly reside broadly in the process wherein the temperature control agent in the heating zone exhibits a temperature of at least 300 degrees Celsius, in one possible exemplification at least 320 degrees Celsius and in yet another possible exemplification at least 340 degrees Celsius, such that the feedstock is very rapidly brought to the starter temperature for the devulcanization.

Still another feature or aspect of an exemplification is believed at the time of the filing of this patent application to possibly reside broadly in the process wherein the feedstock in the starter phase of the devulcanization zone exhibits the required and/or desired starter temperature and after leaving the starter phase exhibits a lower temperature.

A further feature or aspect of an exemplification is believed at the time of the filing of this patent application to possibly reside broadly in the process wherein on starting up the extruder firstly a start temperature is selected that is certainly in the start range and the temperature is reduced stepwise until the optimal start temperature is reached.

Another feature or aspect of an exemplification is believed at the time of the filing of this patent application to possibly reside broadly in the process wherein the process comprises the use of a plurality of dispersion rings, wherein each dispersion ring is associated with a planetary roller module, such that the processing linked with the dispersion rings is carried out on the feedstock in a plurality of steps.

Yet another feature or aspect of an exemplification is believed at the time of the filing of this patent application to possibly reside broadly in the process wherein the opening width of the slit on the dispersion rings is reduced with each processing step, wherein in one possible exemplification the opening width on the second dispersion ring compared to the opening width on the first dispersion ring is at least 5%, in one possible exemplification at least 10%, in another possible exemplification at least 15% less, the third dispersion ring compared to the opening width on the second dispersion ring is at least 5%, in one possible exemplification at least 10%, in another possible exemplification at least 15% and in yet another possible exemplification at least 20% smaller, the third dispersion ring compared to the opening width on the second dispersion ring is at least 5%, in one possible exemplification at least 10%, in another possible exemplification at least 15% and in yet another possible exemplification at least 20% smaller, the fourth dispersion ring compared to the opening width on the third dispersion ring is at least 5%, in one possible exemplification at least 10%, in another possible exemplification at least 15% and in yet another possible exemplification at least 20% smaller, wherein for modifying the slit width the dispersion rings are exchangeable.

Still another feature or aspect of an exemplification is believed at the time of the filing of this patent application to possibly reside broadly in the process wherein the process comprises the use of dispersion rings, whose slit length is defined by the thickness of the dispersion rings and is in one possible exemplification 1 to 25 millimeters, in another possible exemplification 3 to 20 millimeters, wherein the dispersion rings, in one possible exemplification for modifying the slit length are exchangeable.

A further another feature or aspect of an exemplification is believed at the time of the filing of this patent application to possibly reside broadly in the process wherein the process comprises the use of dispersion rings with a conical slit, in one possible exemplification with an inlet conus and/or an outlet conus and/or with rounded edges and/or with a conical surface inclination of 1 to 45 degrees, in another possible exemplification 10 to 35 degrees and in yet another possible exemplification 15 to 30 degrees to the central axis of the dispersion rings.

Another feature or aspect of an exemplification is believed at the time of the filing of this patent application to possibly reside broadly in the process wherein the process comprises the use of dispersion rings, wherein the dispersion rings of the devulcanization zone engage into a groove of the central spindle, wherein the dispersion rings are composed of halves or more segments, wherein the visible corners and edges in the cross section of the groove are in one possible exemplification rounded and/or wherein the groove, in the case where a dispersion ring is exchanged, remains unchanged.

Yet another feature or aspect of an exemplification is believed at the time of the filing of this patent application to possibly reside broadly in the process wherein the process comprises the use of different dispersion rings that on the side of the housing have a collar of constant or substantially constant thickness and on the side of the central spindle engage with a flange into the groove of the central spindle and may have flanges of different thickness.

Still another feature or aspect of an exemplification is believed at the time of the filing of this patent application to possibly reside broadly in the process wherein the process comprises the use of dispersion rings that in a modular composition of an extrusion line can be arranged between two modules.

A further feature or aspect of an exemplification is believed at the time of the filing of this patent application to possibly reside broadly in the process wherein the process comprises the use of dispersion rings that can be arranged together with the thrust rings of planetary roller modules in a common construction, in order to sufficiently strongly deform the material being devulcanized as it passes through the slit.

Another feature or aspect of an exemplification is believed at the time of the filing of this patent application to possibly reside broadly in the process wherein the process comprises the use of modules with a length matched to the desired position of the dispersion rings.

Yet another feature or aspect of an exemplification is believed at the time of the filing of this patent application to possibly reside broadly in the process wherein the process comprises the use of a modularly constructed central spindle, wherein the central spindle comprises a rod, onto which various sleeves have been pushed and, wherein the sleeves are clamped against one another with the rod, in one possible exemplification with sleeves that on their contact surfaces engage in one another with teeth, wherein the sleeves possess a groove in the region of a dispersion ring, such that the dispersion ring can engage into the groove, wherein the sleeves, on their periphery, carry a toothing, with which they mesh with the planetary spindles, and wherein the sleeve is exchangeable with the area forming a groove.

Still another feature or aspect of an exemplification is believed at the time of the filing of this patent application to possibly reside broadly in the process wherein the process comprises the use of a dispersion ring that is arranged before the planetary roller module of the heating zone and encloses the central spindle at a distance, wherein the distance is large enough in order that the material to be devulcanized can be pushed through and at the same time is small enough in order that the material to be devulcanized is strongly deformed as it passes through the gap.

A further feature or aspect of an exemplification is believed at the time of the filing of this patent application to possibly reside broadly in the process wherein the process comprises oil as the temperature control agent that for temperatures above 350 degrees Celsius is employed under nitrogen.

Another feature or aspect of an exemplification is believed at the time of the filing of this patent application to possibly reside broadly in the process wherein the process comprises temperature controlled dispersion rings.

Yet another feature or aspect of an exemplification is believed at the time of the filing of this patent application to possibly reside broadly in the process wherein the process comprises a fill level of the extruder of less than 80%, in one possible exemplification less than 70%, in another possible exemplification less than 50%.

Still another feature or aspect of an exemplification is believed at the time of the filing of this patent application to possibly reside broadly in the process wherein the process comprises an additional degassing of the feedstock after leaving the extruder, wherein the feedstock is mechanically stressed at the extruder end by an additional dispersion ring.

A further feature or aspect of an exemplification is believed at the time of the filing of this patent application to possibly reside broadly in the process wherein the process comprises the use of planetary roller modules with standard spindles for the heating zone and/or for the start phase for the devulcanization and by the use of back-cut spindles and/or transport spindles and/or transversal mixing spindles for the degassing in the devulcanization zone.

Another feature or aspect of an exemplification is believed at the time of the filing of this patent application to possibly reside broadly in the process wherein the process comprises the production of a product with a Mooney viscosity of 20 to 60, in one possible exemplification 30 to 50, in another possible exemplification 35 to 45, measured at a temperature of 100 degrees Celsius.

The components disclosed in the patents, patent applications, patent publications, and other documents disclosed or incorporated by reference herein, may possibly be used in possible exemplifications of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one exemplification of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various exemplifications may be used with at least one exemplification or all of the exemplifications, if more than one exemplification is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications, patent publications, and other documents cited herein, and in the Declaration attached hereto, are hereby incorporated by reference as if set forth in their entirety herein except for the exceptions indicated herein.

The summary is believed, at the time of the filing of this patent application, to adequately summarize this patent application, However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, patent applications, patent publications, and other documents which are included in this application and which are referred to in paragraphs which state “Some examples of . . . which may possibly be used in at least one possible exemplification of the present application . . . ” may possibly not be used or useable in any one or more exemplifications of the application.

The sentence immediately above relates to patents, patent applications, patent publications, and other documents either incorporated by reference or not incorporated by reference.

The following issued U.S. patents and/or published U.S. patent applications are incorporated by reference herein: US 2015/0283728, published Oct. 8, 2015; US 2015/0043300, published Feb. 12, 2015; U.S. Pat. No. 9,193,106, issued Nov. 24, 2015; and U.S. Pat. No. 8,957,119, issued Feb. 17, 2015.

All of the patents, patent applications, patent publications, and other documents, except for the exceptions indicated herein, which were cited in the International Search Report dated Aug. 2, 2016, and/or cited elsewhere, as well as the International Search Report document itself, are hereby incorporated by reference as if set forth in their entirety herein except for the exceptions indicated herein, as follows: “An introduction of the planetary roller extruder and areas of applications rubber devulcanization” by Michael W Batton, Thomas J Malzahn, Michael Gerdon, and Ralf Quack, published in Proceedings of Antec 2015, 25 Mar. 2015, SPE—Society of Plastics Engineers, pages 1-4; and EP 2164895 A1, published on Mar. 24, 2010, having applicant RHEIN CHEMIE RHEINAU GMBH.

The corresponding foreign and international patent publication applications, namely, Federal Republic of Germany Patent Application No. 10 2015 010 460, filed on Aug. 16, 2015, having inventor Harald RUST, and DE-OS 10 2015 010 460 and DE-PS 10 2015 010 460, and International Application No. PCT/EP2016/001015, filed on Jun. 16, 2016, having WIPO Publication No. WO 2017/028936 A1 and inventor Harald RUST, are hereby incorporated by reference as if set forth in their entirety herein, except for the exceptions indicated herein, for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications, patent publications, and other documents, except for the exceptions indicated herein, are hereby incorporated by reference as if set forth in their entirety herein except for the exceptions indicated herein.

The purpose of incorporating the corresponding foreign equivalent patent application(s), that is, PCT/EP2016/001015 and German Patent Application 10 2015 010 460, is solely for the purposes of providing a basis of correction of any wording in the pages of the present application, which may have been mistranslated or misinterpreted by the translator, and to provide additional information relating to technical features of one or more exemplifications, which information may not be completely disclosed in the wording in the pages of this application.

Statements made in the original foreign patent applications PCT/EP2016/001015 and DE 10 2015 010 460 from which this patent application claims priority which do not have to do with the correction of the translation in this patent application are not to be included in this patent application in the incorporation by reference.

Any statements about admissions of prior art in the original foreign patent applications PCT/EP2016/001015 and DE 10 2015 010 460 are not to be included in this patent application in the incorporation by reference, since the laws relating to prior art in non-U.S. Patent Offices and courts may be substantially different from the Patent Laws of the United States.

All of the references and documents cited in any of the patents, patent applications, patent publications, and other documents cited herein, except for the exceptions indicated herein, are hereby incorporated by reference as if set forth in their entirety herein except for the exceptions indicated herein. All of the patents, patent applications, patent publications, and other documents cited herein, referred to in the immediately preceding sentence, include all of the patents, patent applications, patent publications, and other documents cited anywhere in the present application.

Words relating to the opinions and judgments of the author of all patents, patent applications, patent publications, and other documents cited herein and not directly relating to the technical details of the description of the exemplifications therein are not incorporated by reference.

The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned words in this sentence, when not used to describe technical features of one or more exemplifications of the patents, patent applications, patent publications, and other documents, are not considered to be incorporated by reference herein for any of the patents, patent applications, patent publications, and other documents cited herein.

The description of the exemplification or exemplifications is believed, at the time of the filing of this patent application, to adequately describe the exemplification or exemplifications of this patent application. However, portions of the description of the exemplification or exemplifications may not be completely applicable to the claims as originally filed in this patent application, as amended during prosecution of this patent application, and as ultimately allowed in any patent issuing from this patent application. Therefore, any statements made relating to the exemplification or exemplifications are not intended to limit the claims in any manner and should not be interpreted as limiting the claims in any manner.

The details in the patents, patent applications, patent publications, and other documents cited herein may be considered to be incorporable, at applicant's option, into the claims during prosecution as further limitations in the claims to patentably distinguish any amended claims from any applied prior art.

While various aspects and exemplifications have been disclosed herein, other aspects and exemplifications are contemplated. The various aspects and exemplifications disclosed herein are for purposes of illustration and not intended to be limiting. Additionally, the words “including,” “having,” and variants thereof (e.g., “includes” and “has”) as used herein, including the claims, shall be open-ended and have the same meaning as the word “comprising” and variants thereof (e.g., “comprise” and “comprises”).

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the exemplification or exemplifications, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. § 1.72(b). As stated in 37 C.F.R. § 1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The exemplifications of the invention described herein above in the context of the preferred exemplifications are not to be taken as limiting the exemplifications of the invention to all of the provided details thereof, since modifications and variations thereof may be made without departing from the spirit and scope of the exemplifications of the invention.

What is claimed is:

1. A method of devulcanizing vulcanized material comprising cross-linked rubber or cross-linked elastomers, using a planetary roller extruder comprising a housing, a central spindle, and planetary spindles disposed between and configured to mesh with said central spindle and said housing, said method comprising the steps of:
feeding vulcanized material into a feed zone of said planetary roller extruder;
operating said planetary roller extruder by rotating said central spindle about its rotational axis, and thereby both rotating said planetary spindles about each of their rotational axes and revolving said planetary spindles about said central spindle;
feeding vulcanized material from said feed zone into a first treatment zone;
generating mechanical and thermal stress on said vulcanized material in said first treatment zone by kneading and/or crushing to begin devulcanization;
feeding treated vulcanized material from said first treatment zone, through a dispersion ring, and to a second treatment zone, and generating additional mechanical and thermal stress on said treated vulcanized material by restricting movement of said vulcanized material through said dispersion ring;
generating additional mechanical and thermal stress on said treated vulcanized material in said second treatment zone by kneading and/or crushing to further and/or complete devulcanization; and
said step of generating mechanical and thermal stress on said vulcanized material in said first treatment zone comprising:
(A) heating said vulcanized material in a heating zone, which heating zone comprises its own set of planetary rollers and temperature control; and/or
(B) starting devulcanization in a start zone, which start zone comprises its own set of planetary rollers and temperature control.

2. The method according to claim 1, wherein the length of said heating zone and/or said start zone, relative to the diameter of the pitch circle the toothing on the inside of said housing, are as follows:

| Diameter Size | Module length | Module length |
|---|---|---|
| of Pitch Circle | Heating zone | Start zone |
| 50 to 70 mm | 100 to 300 mm | 100 to 300 mm |
| 100 to 150 mm | 250 to 600 mm | 250 to 650 mm |
| 170 to 250 mm | 300 to 650 mm | 300 to 650 mm |
| 280 to 300 mm | 320 to 800 mm | 320 to 800 mm |
| 350 mm | 300 to 650 mm | 300 to 650 mm |
| 400 mm | 320 to 800 mm | 120 to 800 mm |
| 400 mm | 320 to 800 mm | 320 to 800 mm |
| 500 to 1000 mm | 350 to 1000 mm | 350 to 1000 mm. |

3. The method according to claim 2, wherein said step of heating said vulcanized material in said heating zone comprises quickly raising the temperature of said vulcanized material to a starter temperature for devulcanization using a temperature control agent having a temperature of one of: (C) at least 300° C., (D) at least 320° C., and (E) at least 340° C.

4. The method according to claim 3, wherein said vulcanized material in said start zone exhibits the required starter temperature and after leaving said start zone exhibits a lower temperature.

5. The method according to claim 4, wherein said method further comprises selecting and setting a start temperature that is sufficiently high to be in a start range, and then reducing the selected temperature in steps until an optimal start temperature is reached.

6. The method according to claim 5, wherein said planetary roller extruder comprises a plurality of dispersion rings and a plurality of planetary roller modules, wherein each dispersion ring is associated with a corresponding planetary roller module, such that processing linked with the dispersion rings is carried out on said vulcanized material in a plurality of steps.

7. The method according to claim 6, wherein:
each of said dispersion rings is disposed about said central spindle with space therebetween, such that slits are formed between said dispersion rings and said central spindle ro permit vulcanized material to pass through;
the opening width of the slits is reduced with each processing step or with each planetary roller module, wherein:
the opening width of a second dispersion ring compared to the opening width of a first dispersion ring is one of: at least 5% less, at least 10% less, or at least 15% less;
the opening width of a third dispersion ring compared to the opening width of said second dispersion ring is one of: at least 5% less, at least 10% less, at least 15% less, or at least 20% less; and
the opening width of a fourth dispersion ring compared to the opening width of said third dispersion ring is one of: at least 5% less, at least 10% less, at least 15% less, or at least 20% less; and
said dispersion rings are exchangeable in order to permit modification of the opening width of said slits.

8. The method according to claim 7, wherein the lengths of said slits are defined by the thicknesses of said dispersion rings, which thicknesses are in the range of 1 to 25 mm, or are in the range of 3 to 20 mm, and the dispersion rings are exchangeable in order to permit modification of the lengths of said slits.

9. The method according to claim 8, wherein said slits comprise a conical shape, with an inlet conus and/or an outlet conus and/or with rounded edges and/or with a conical surface inclination, with respect to the central axis of said dispersion rings, in the range of: 1 to 45°, 10 to 35°, or 15 to 30°.

10. The method according to claim 9, wherein:
said central spindle comprises groove portions about which said dispersion rings are disposed;
said dispersion rings are composed of halves or a plurality of segments;
the outer surface of each of said groove portions is rounded or cylindrical; and
said groove portions remain unchanged in the event of an exchange of dispersion rings.

11. The method according to claim 10, wherein some of said dispersion rings have different sizes and/or dimensions and/or shapes, wherein said different dispersion rings, on the side adjacent the housing, comprise a collar of constant thickness, and, on the side adjacent the central spindle, comprise a flange configured to engage with said groove portions, which flanges have different thickness.

12. The method according to claim 11, wherein said dispersion rings are configured to be placed between two planetary roller modules, and are configured to be arranged together with thrust rings of planetary roller modules in a single arrangement, in order to sufficiently strongly deform the vulcanized material being devulcanized as it passes through said slits.

13. The method according to claim 12, wherein said planetary roller modules have a length selected to permit a desired positioning of said dispersion rings.

14. The method according to claim 13, wherein:
said central spindle has a modular construction;
said central spindle comprises a rod and a plurality of sleeves that disposed on said rod;
said sleeves are clamped against one another with contact surfaces that engage in one another with teeth;
said sleeves comprise a groove configured to engage with a dispersion ring;
each of said sleeves comprises a toothing on its periphery that is configured to mesh with said planetary spindles; and
said sleeves are exchangeable to change said grooves.

15. The method according to claim 14, wherein one of said dispersion rings is disposed before said heating zone, and the opening width of said slit is sufficiently large to permit the vulcanized material to be pushed through but sufficiently small to promote strong deformation of the vulcanized material.

16. The method according to claim 15, wherein said method further comprises:
controlling the temperature at said planetary roller modules using a temperature control medium, which temperature control medium comprises oil; and
preventing ignition of said oil at temperatures over 350° C. using nitrogen.

17. The method according to claim 16, wherein said method further comprises controlling the temperature at said dispersion rings.

18. The method according to claim 17, wherein said method further comprises filling said planetary roller extruder with vulcanized material to a fill level of less than 80%, or less than 70%, or less than 50%.

19. The method according to claim 18, wherein said method further comprises an additional degassing of said vulcanized material after leaving said planetary roller extruder, wherein said vulcanized material is mechanically stressed at the end of said planetary roller extruder by an additional dispersion ring.

20. The method according to claim 19, wherein:
said planetary roller modules in said heating zone and/or said start zone comprise standard spindles;
said planetary roller modules in said second treatment zone comprise back-cut spindles and/or transport spindles and/or transversal mixing spindles for degassing;
said method further comprises producing a devulcanized material having a Mooney viscosity of 20 to 60, or 30 to 50, or 35 to 45, as measured at a temperature of 100° C.
